(19) United States
(12) Patent Application Publication
(10) Pub. No.: US 2013/0339497 A1
(43) Pub. Date: Dec. 19, 2013

(54) CONFIGURING DEVICES IN A NETWORK

(71) Applicants: Suad MOHAMED, Acton, MA (US); Vijay VALLALA, North Andover, MA (US); François BECK, Chateauneuf (FR); Jose PETIT, Sophia-Antipolis Cedex (FR)

(72) Inventors: Suad MOHAMED, Acton, MA (US); Vijay VALLALA, North Andover, MA (US); François BECK, Chateauneuf (FR); Jose PETIT, Sophia-Antipolis Cedex (FR)

(73) Assignee: Schneider Electric Industries, SAS, Rueil Malmaison (FR)

(21) Appl. No.: 13/495,484

(22) Filed: Jun. 13, 2012

(51) Int. Cl. G06F 15/177

(52) U.S. Cl. 709/221

(57) ABSTRACT

A system, method, and computer readable medium are provided for configuring devices in a network, such as an Industrial Ethernet network. An application program includes application-specific configuration data intended to configure one or more devices in the network. The configuration data may be exported from the application and saved in one or more files. When each device boots up, it performs a network query to obtain its configuration data from a corresponding one of the files. Each device may perform a standardized network query, such as a DHCP query, to obtain preliminary network configuration data. Thereafter, the device may use another standard networking protocol, such as FTP or TFTP, to query its application-specific configuration data from a configuration file. Thereafter, the device and the application program may communicate according to the configuration parameters.

### BACKGROUND

Industrial automation systems often include a Programmable Logic Controller (PLC) coupled to other devices, such as I/O devices, over one or more communication networks. Such systems may include sensors, motors, valves, and other devices that are controlled or monitored through the I/O devices. The PLC may include rules for acting on changing conditions, such as issuing commands to devices over the network to perform various operations in the system. The PLC may also monitor and report on the status of various operating parameters and errors detected in the system.

As shown in FIG. 1, for example, a user console 101 is coupled to a programmable logic controller (PLC) 102. Console 101 may comprise one or more processors and memory storing application software and/or a user interface that allows a user or a computer program to configure, alter, control, and monitor the operation of functions in PLC 102 and a network in which the PLC operates. PLC 102 may comprise any of various types of commercially available PLCs, such as the Modicon™ Quantum™ PLC available from Schneider Electric. As shown in FIG. 1, the PLC may execute one or more applications 113 that control the operation of the system and receive inputs from devices in the system.

PLC 102 may be coupled to one or more communication controllers 103 and 104 through a backplane interconnection or other means. Each communication controller handles communication with one or more I/O devices, such as devices 105, 106, and 107, over one or more networks 108 and 109, for the purpose of monitoring and controlling various devices such as actuators and sensors in the system. I/O device 105 may be associated with a sensor 110, such as a temperature sensor. I/O device 106 may be associated with a motor 111, whereas I/O device 107 may be associated with a valve 112. In some variations, one I/O device may be associated with two or more devices.

The system shown in FIG. 1 can be used to monitor and operate an industrial system.

Networks 108 and 109 may comprise an Industrial Ethernet, which may optionally operate according to the EtherNet/Industrial Process (EtherNet/IP) protocol.

In order to configure I/O devices 105 through 107, a vendor-specific configuration tool is typically provided on user console 101 for the purpose of transmitting proprietary commands over networks 108 and 109 to each device. For example, a human user may be required to step through various user interfaces that cause configuration commands to be transmitted to and from the various I/O devices in order to establish their operating parameters so that they will thereafter operate according to a desired application program 113. This approach may lead to human errors, in part because the person doing the configuration may be different from the person that created the application 113. Additionally, the PLC may need to periodically monitor which Ethernet-connected devices are ready to be configured, contributing to network traffic and generally slowing down the operation of PLC 102.

It would be desirable to improve the configuration process for devices in a system such as that shown in FIG. 1.

### SUMMARY

Described herein are a system, method, and computer readable medium for configuring devices in a network, such as an Industrial Ethernet network. In some variations, an application program includes application-specific configuration data intended to configure one or more devices in the network. The configuration data may be exported from the application and saved in one or more files. When each device boots up, it performs a network query to obtain its configuration data from a corresponding one of the files.

In some variations, each device may perform a standardized network query, such as a DHCP query, to obtain preliminary network configuration data. A server (e.g., a DHCP server) may respond with preliminary network configuration data (e.g., an IP address).

Next, the device may use another standard networking protocol, such as FTP or TFTP, to query its application-specific configuration data from a configuration file. Thereafter, the device and the application program may communicate according to the operating parameters.

Also described herein is a computer-readable medium, such as a memory device, including executable instructions that, when executed, perform functions relating to the method and system described above.

### BRIEF DESCRIPTION OF THE DRAWINGS

A more complete understanding of the present disclosure and the potential advantages of various aspects described herein may be acquired by referring to the following description in consideration of the accompanying drawings, in which like reference numbers indicate like features, and wherein:

FIG. 1 is a block diagram of an industrial automation system including a PLC and various network elements.

FIG. 2 is block diagram of a system configured to operate according to various principles described herein.

FIG. 3 is a flowchart showing various steps or functions that may be performed according to various principles described herein.

FIG. 4 shows message flows among components.

FIG. 5 shows a device that may be used to implement various functions described herein.

### DETAILED DESCRIPTION

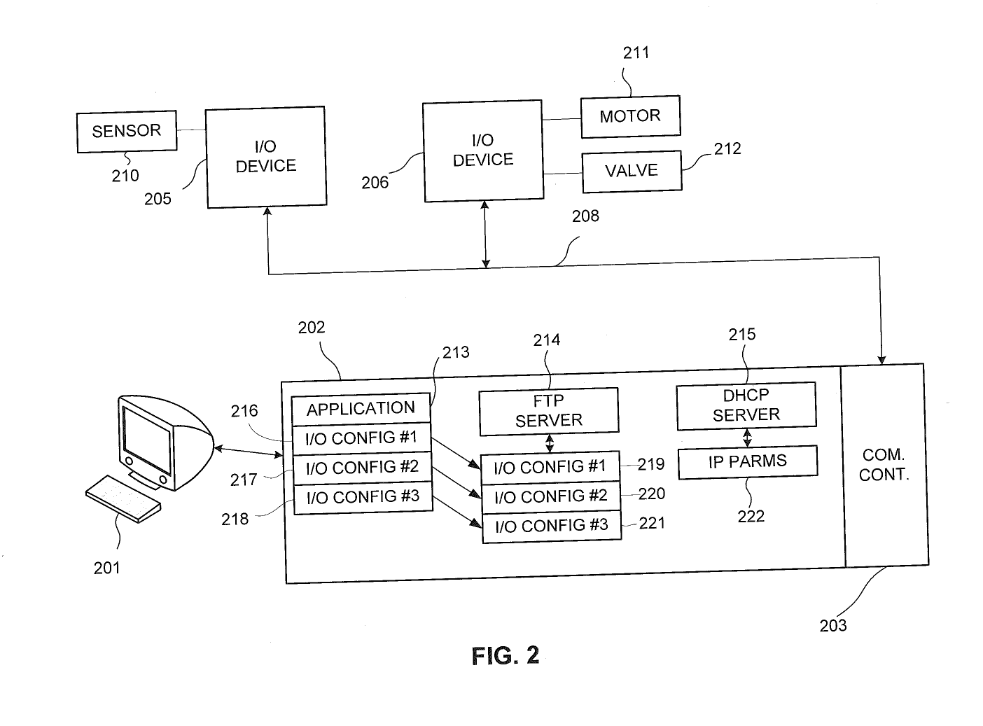

FIG. 2 is a block diagram of a system configured to operate according to various principles described herein. As shown in FIG. 2, a programmable logic controller (PLC) 202 is coupled to a console 201. PLC 202 may comprise one or more processors and memories having stored therein executable instructions that, when executed, cause PLC 202 to perform various functions as described herein. Using this arrangement, a user of console 201 may create and/or install an application program 213 to execute on PLC 202.

It is assumed that application program 213 will communicate with I/O devices 205 and 206 in order to receive updates from them and/or control them or devices associated with them. For example, application 213 may receive updates from sensor 210 through I/O device 205 and, based on the updates, issue commands to motor 211 and valve 212 through I/O device 206. Network 208 may comprise an Ethernet-compatible network, such as an Industrial Ethernet, and may optionally use EtherNet/IP protocols.

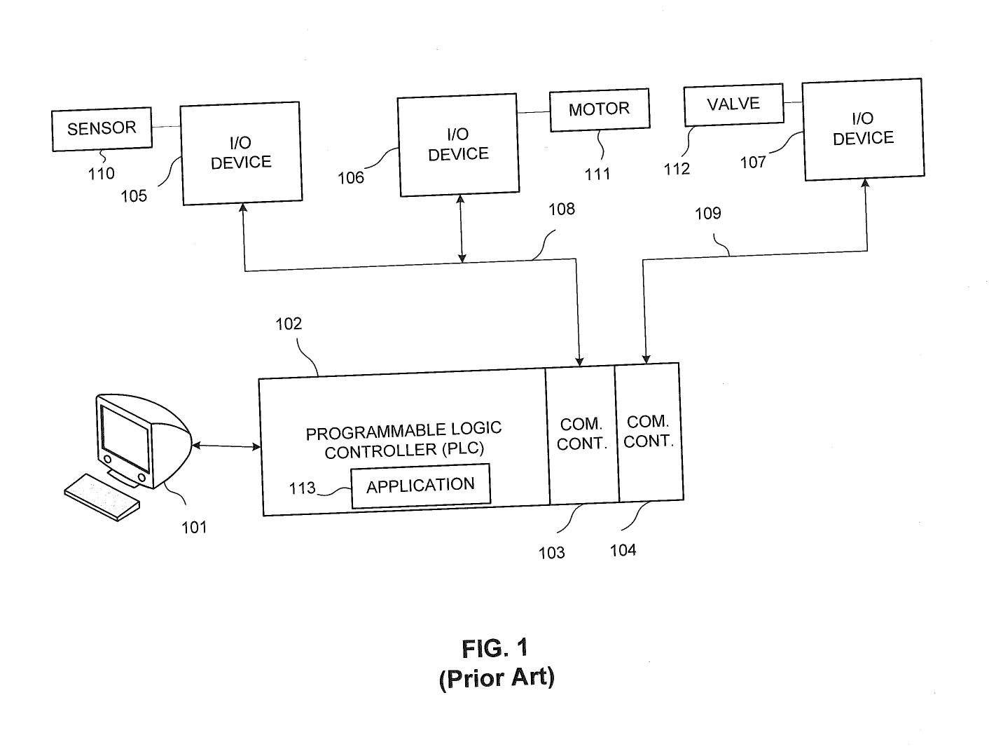

In contrast to the configuration shown in FIG. 1, in which each I/O device is configured by a user using a special tool on console 201, application 213 includes I/O configuration data 216, 217, and 218, each of which is intended to be used to configure each respective I/O device 205 and 206 (and their corresponding devices 210, 211, and 212). For example, sensor 210 may be configured to transmit sensor updates every 100 milliseconds, with a 300-millisecond timeout value. As another example, motor 211 may be configured to perform a ramp-down motor stop as opposed to a sudden stop. As yet another example, valve 212 may be configured to only move within a certain range of motion defined by configurable parameters. Other examples include voltage or current levels or ranges, forward/reverse settings, error conditions or thresholds, associating a user task to modules, configuring a holdup time to maintain output values for a certain time, or associating rack or slot addresses with a device. Yet other examples include defining a known safe-state value for an I/O device to go to when an error occurs, setting a water pressure monitoring value, input ranges, output ranges, resolutions, filter configurations, precision, hysteresis, edge detection, and fallback strategies. Such application-specific configuration parameters may be used to configure each I/O device, which in turn controls and interacts with sensor 210, motor 211, and valve 212 over network 208 through communication controller 203.

In some embodiments, a software tool (not shown) may be used to cause application 213 to export the application-specific configuration data into separate files 219 through 221, one per device in the system. In some variations, one configuration file may be provided per I/O device, even for I/O devices such as device 206 that controls and interfaces to more than one device (e.g., motor 211 and valve 212). In other variations, separate configuration files may be provided for each device (e.g., devices 210, 211, and 212), even though some of the devices (e.g., motor 211 and valve 212) share the same I/O device 206.

In one variation, when application 213 begins execution, it automatically exports configuration data 216, 217 and 218 into a known memory area or a set of files. A software tool may be used to move this data into a set of files (e.g., files 219, 220 and 221) that can be read by an FTP server 214 in order to supply configuration data to the devices in the system.

Instead of using a software tool to export configuration data when application 213 is loaded into PLC 202, the configuration data intended to be used with application 213 may be separately loaded into the memory of PLC 202. In other words, the configuration files 219 through 221 may be loaded from console 201 when application 213 is loaded into PLC 202. The configuration files may be associated with a particular device by using a file naming convention, as discussed in more detail below.

As shown in FIG. 2, PLC 202 also hosts a DHCP server 215 and an FTP server 214.

DHCP refers to the well-known Dynamic Host Configuration Protocol (see RFC 2131 for IPv4 networks, and RFC 3315 for IPv6 networks). FTP refers to File Transfer Protocol, and is intended to encompass variations such as TFTP (Trivial File Transfer Protocol), which is a simplified version of FTP.

DHCP server 215 may include a pool of IP addresses 222 and other IP parameters that may be “leased” to devices that query server 215 upon boot-up, in order to establish basic communication paths on network 208. Using the known DHCP protocols, devices that become active on the network broadcast a discovery message over network 208 to discover available DHCP servers. In response, DHCP servers such as server 215 respond with a message providing an IP address that may be used to communicate with other devices on network 208. The request and response thus establish, at a minimum, a correspondence between a Media Access Control (MAC) hardware address corresponding to the specific I/O device and an IP address used for communicating over network 208 with that device.

FTP server 214 may provide file-access services (e.g., file retrieval and file storage) to devices on network 208. In some embodiments, FTP server 214 allows I/O devices such as device 205 and device 206 to query one or more configuration files for devices. As shown in FIG. 2, FTP server 214 allows I/O devices 205 and 206 to retrieve one or more of configuration files 219 through 221, in order to configure such devices to operate with application-specific operating parameters, such as those described above.

In some variations, I/O device configuration occurs in a two-step process. In a first step, when each I/O device boots up, it performs a DHCP query to DHCP server 215 to obtain an IP address for further communication on network 208. This step performs network-level configuration sufficient to enable communication with other devices on network 208. In a second step, the I/O device performs an FTP query through server 214 to obtain application-specific operating parameters from a corresponding configuration file, such as one of files 219 through 221. In both cases, the I/O device itself performs the query and configuration, alleviating application 213 of the need to monitor devices on the network, and avoiding the need for a human to manually configure the devices from console 201.

In some variations, each I/O device may identify a configuration file by specifying a unique filename that is selected by convention. For example, the file name may comprise a combination of various fields such as a device type, a device MAC address, a device serial number, or other identifying information that will be known by the I/O device that requests the file. For example, I/O device 205 may be initialized internally to be known as SENSOR001, and may have a MAC address of 00:22:4A:5F:23. Accordingly, its configuration filename may be specified by convention to be the concatenation SENSOR00100224A5F23. As another example, the filename may comprise a device name along with a device number, such as a serial number. Virtually any combination of characters that would be known by both the application program and each device may be used to specify a unique filename.

Because I/O device 206 controls two devices (motor 211 and valve 212), it may be arranged to separately request two configuration files, one for each device, when it boots up. Consequently, it may request configuration file 220 to configure motor 211, and configuration file 221 to configure valve 212.

The existence of a unique configuration filename established a priori by convention means that both application 213 and device 205 know in advance the file that contains the application-specific parameter configuration data for sensor 210. Hence, when I/O device 205 boots up, it knows to query this file by name using FTP server 214. Moreover, application 213 knows to export the configuration data for this device into a file having a specific name, established by convention. In some embodiments, the file name is selected to be unique at least at the PLC level, such that no other configuration files have the same name. The name may be an aggregation of two or more pieces of information, such as a fixed prefix value that is specific to a product or a range of products, and a variable value that can be set using a key pad, rotary switch, or web page. For example, for a sensor type of device, the prefix may be “SENSOR_” and the variable value may be set with a key pad to a value such as 01, so the file of the sensor would be SENSOR_{—}01.

In some variations, configuration files 219 through 221 may be stored in a standard file system, such as a FAT32 file system, that is compatible with FPT server 214 and DHCP server 215.

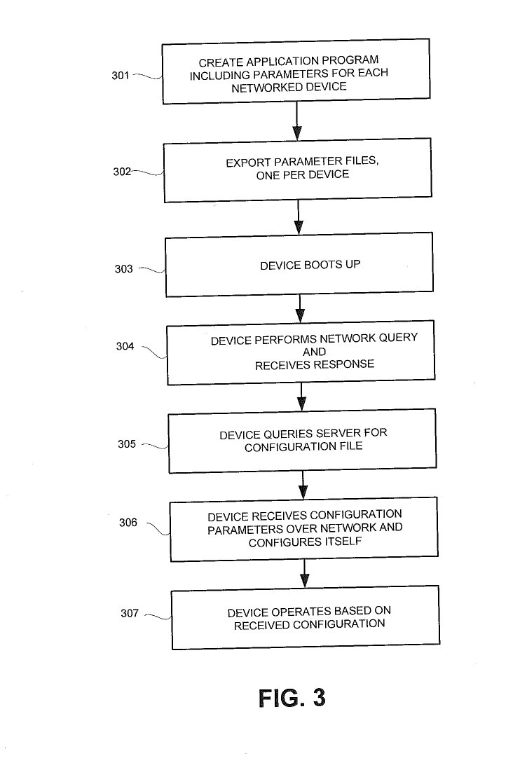

FIG. 3 shows various steps of a method that may be performed. In step 301, an application program is created, including application-specific operating parameters for each networked device. As explained above, these may include operating conditions and other settings for operating each device according to the application program.

In step 302, the operating parameters for one or more devices intended to operate with the application program may be exported, such as into a memory area in a PLC or a file having a unique name. As explained above, instead of exporting the operating parameters from the application program, the operating parameters may instead be stored in a file using a filename convention sufficient to allow the device to access the configuration information.

In step 303, the device that will be controlled by the application boots up. It is assumed that the device is coupled to a network, such as an Ethernet (e.g., Industrial Ethernet or similar network).

In step 304, the device performs a network query to obtain communication parameters for communicating on the network. In one embodiment, the network query comprises a DHCP query that is responded to by a DHCP server. The DHCP server may provide an IP address for the device, as well as other network operating parameters used for communicating in the network.

In step 305, the device performs a second query over the network to obtain application-specific operating parameters. In some variations, this second query is performed using a standard file transfer protocol, such as FTP or TFTP, and by specifying a unique filename corresponding to the device performing the query.

In step 306, the device receives the application-specific operating parameters and configures itself (including possibly a connected device if necessary) to operate using the received parameters.

In step 307, the device operates based on the received operating parameters. This may include communicating with the application program in the PLC.

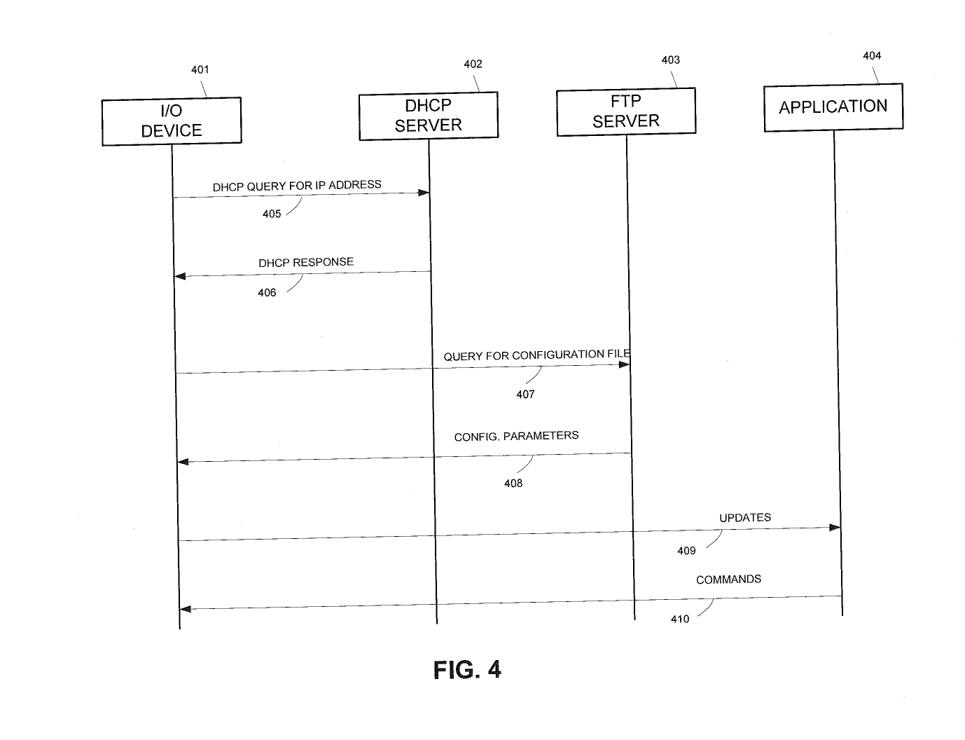

FIG. 4 shows message flows among components, including an I/O device 401, a network configuration server such as DHCP server 402, a file server such as FTP server 403, and an application such as application 404.

In step 405, I/O device 401 performs a network query for one or more network parameters used for communicating on the network. This may comprise, for example, a DHCP query for an IP address.

In step 406, a network server such as DHCP server 402 responds with network operating parameters, such an IP address.

In step 407, I/O device 401 performs a second query for a configuration file storing application-specific operating parameters. For example, it may perform an FTP file request to an FTP server for a configuration file having a unique name that is known a priori by the I/O device.

In step 408, the file server may respond with a file comprising one or more application-specific operating parameters. The I/O device may thereafter configure itself based on the application-specific operating parameters.

In step 409, the I/O device may provide updates to application 404 (e.g., temperature sensor values), and may receive commands and output data 410 from application 404 over the network.

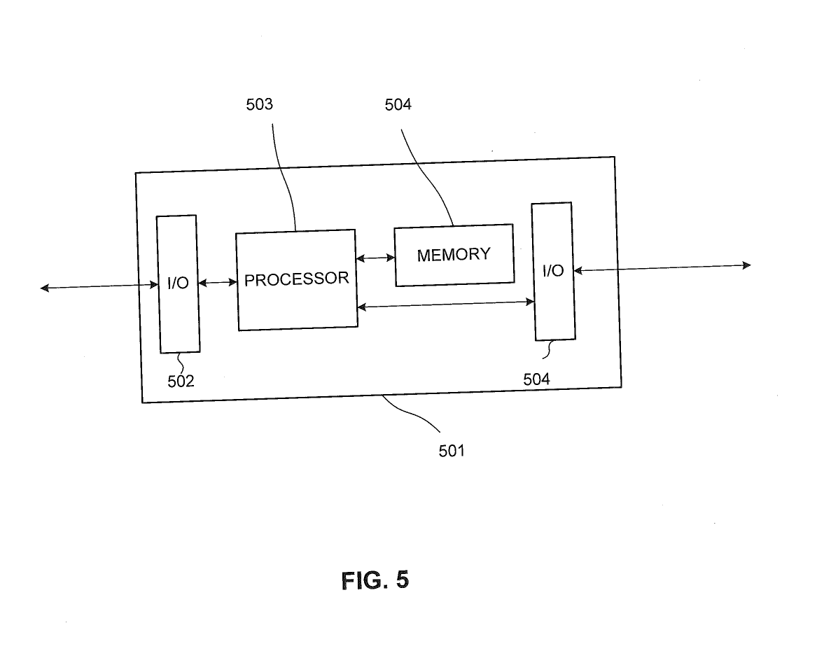

FIG. 5 shows an apparatus that can be used to implement devices such as those shown in FIG. 2. Device 501, such as PLC 202 or I/O device 205, may include one or more processors 503 and one or more memories 504 having stored therein instructions that perform the functions described above and shown in FIGS. 3 and 4. The device may also include one or more I/O circuits 502 and 504 to communicate with other devices on the network through ports. References to a processor and memory are also intended to encompass various types of processing structures including, but not limited to, application-specific integrated circuits (ASICs) and field programmable gate arrays (FPGAs).

The functions and steps described above may be implemented by hardware and/or by software stored in tangible computer-readable media (e.g., a memory) and executed by various computing devices or apparatus, such as a server computer including one or more processors programmed with software.

The divisions between functional blocks in the figures are merely illustrative, and the physical division of computing devices and other equipment may be different from the functional division. Moreover, some or all of the functional blocks may be combined or further subdivided functionally and/or physically. For example, devices 201 and 202 could be combined into a single device, and even the functions of console 101 could be combined into a single device, such as an industrial PC.

As used herein, the term “File Transfer Protocol” or FTP refers to not only the standard FTP protocol, but variants thereof, specifically including Trivial File Transfer Protocol (TFTP).

As used herein, the term “filename” should be understood to encompass a combination of directory structure in combination with a filename.

Unless otherwise explicitly stated, steps of method claims (and corresponding functional elements) herein should not be limited to being performed in the order in which they are recited.

What is claimed is:

1. A method, comprising:
providing a configuration file having a filename specified by convention to be associated with one or more devices in a network, wherein the configuration file comprises application-specific configuration parameters for configuring one of the one or more devices;
performing a first network query over the network from the one device to obtain one or more network communication parameters;
in response to the first network query, receiving the one or more network communication parameters and configuring the one device to communicate over the network based on the one or more network communication parameters;
performing a second network query over the network from the one device to retrieve the configuration file based on the filename; and
in response to the second network query, receiving the configuration file and configuring the one device to operate according to the application-specific configuration parameters contained in the configuration file.

2. The method of claim 1, wherein the configuration file was previously exported from an application program in a programmable logic controller (PLC).

3. The method of claim 1, wherein the first query comprises a Dynamic Host Configuration Protocol (DHCP) query, and wherein the one or more network communication parameters comprises an IP address.

4. The method of claim 1, wherein the second query comprises a File Transfer Protocol (FTP) query and wherein the configuration file is retrieved from an FTP server in a Programmable Logic Controller (PLC).

5. The method of claim 1, wherein the network comprises an Industrial Ethernet.

6. The method of claim 1, wherein the filename is specified by concatenating a device name with a device identifier.

7. The method of claim 6, wherein the filename comprises a Media Access Control (MAC) address of the one device.

8. The method of claim 1, wherein the filename is unique among configuration file names on a PLC.

9. The method of claim 1, wherein the configuration file is downloaded to a PLC in connection with an application program.

10. The method of claim 1, further comprising the step of causing an application program to operate with the one device based on the application-specific configuration parameters.

11. Apparatus comprising:
a processor; and
a memory storing instructions that, when executed by the processor, cause the apparatus to:
store a configuration file having a filename specified by convention to be associated with one or more devices in a network, wherein the configuration file comprises application-specific configuration parameters for configuring one of the one or more devices in the network;
in response to receiving a first network query over the network from the one device, provide one or more network communication parameters to configure the one device to communicate over the network based on the one or more network communication parameters;
in response to receiving a second network query over the network from the one device, retrieve the configuration file based on the filename and provide the retrieved configuration file to the one device, wherein the one device configures itself to operate according to the application-specific configuration parameters in the configuration file.

12. The apparatus of claim 11, wherein the configuration file was previously exported from an application program in a programmable logic controller (PLC).

13. The apparatus of claim 11, wherein the first query comprises a Dynamic Host Configuration Protocol (DHCP) query, and wherein the one or more network communication parameters comprises an IP address.

14. The apparatus of claim 11, wherein the second query comprises a File Transfer Protocol (FTP) query and wherein the configuration file is retrieved from an FTP server in a Programmable Logic Controller (PLC).

15. The apparatus of claim 11, wherein the network comprises an Industrial Ethernet.

16. The apparatus of claim 11, wherein the filename is specified by concatenating a device name with a device identifier.

17. The apparatus of claim 16, wherein the filename comprises a Media Access Control (MAC) address of the one device.

18. The apparatus of claim 11, wherein the filename is unique among configuration file names on a PLC.

19. The method of claim 11, wherein the configuration file is downloaded to a PLC in connection with an application program.

20. A memory storing executable instructions that, when executed by a processor, cause an apparatus containing the processor to:
store a configuration file having a filename specified by convention to be associated with one or more devices in a network, wherein the configuration file comprises application-specific configuration parameters for configuring one of the one or more devices in the network;
in response to receiving a first network query over the network from the one device, provide one or more network communication parameters to configure the one device to communicate over the network based on the one or more network communication parameters;
in response to receiving a second network query over the network from the one device, retrieve the configuration file based on the filename and provide the retrieved configuration file to the one device, wherein the one device configures itself to operate according to the application-specific configuration parameters in the configuration file.
